(19) United States
(12) Patent Application Publication
(10) Pub. No.: US 2011/0262682 A1
(43) Pub. Date: Oct. 27, 2011

(54) KNITTED GEOTEXTILE, AND GEOTEXTILE TUBE CONSTRUCTED THEREOF

(76) Inventors: Jonathan R. Wynn, Gloucestershire (GB); John Thompson, Derbyshire (GB)

(21) Appl. No.: 13/124,449

(22) PCT Filed: Oct. 16, 2009
(86) PCT No.: PCT/US09/05652

§ 371 Date: Jun. 20, 2011

Related U.S. Application Data
(60) Provisional application No. 61/136,946, filed on Oct. 16, 2008.

(51) Int. Cl. B32B 5/26

(52) U.S. Cl. 428/91

(57) ABSTRACT

A geotextile for sediment dewatering and containment has a pattern of oriented warp fibers positioned substantially parallel to each other, a pattern of oriented weft inserted fibers positioned substantially parallel to each other and substantially perpendicular to the oriented warp fibers, a nonwoven fleece, and oriented knitting fibers that interconnect the warp fibers, the weft fibers, and the nonwoven fleece as a knitted structure. Because of the knitted configuration, the load bearing warp fibers and weft fibers remain substantially straight rather than interlaced as in a woven product. Consequently, the load bearing warp fibers and weft fibers take up stress immediately, thereby giving higher performance at lower strain. Because the load bearing warp fibers and weft fibers are substantially straight, they also retain their permeability under loading. Since more water flows through and from the geotextile, even when fully loaded, the dewatering process is both faster and safer to complete

### BACKGROUND OF THE INVENTION

1. Field of the Invention

The present invention generally relates to a geotextile for sediment dewatering and containment. More specifically, the present invention relates to a knitted geotextile for sediment dewatering and containment, and to a geotextile tube constructed thereof.

2. Description of the Prior Art

Geotextile tubes offer an economical and environmentally friendly alternative to conventional remediation and civil engineering projects. Typical geotextile tube applications include: dewatering and containment of fine-grained silty material; dewatering and containment of mining and industrial waste, sewage sludge, and contaminated waste; and dredging and erosion control.

A very small number of conventional tubes have been manufactured using non-woven technology involving needle-punching of staple fibers. To date, however, the overwhelming majority of conventional geotextile tubes have been constructed of a woven material using common weaving technology.

A problem associated with such woven fabrics, however, is that the weaving technology produces tubes that exhibit certain performance disadvantages. These performance disadvantages unfavorably impact the economic value derived by the tube user for at least the following reasons.

First, a conventional woven fabric has warp (i.e., fiber oriented in the machine direction—MD) and weft (i.e., fiber oriented in the cross direction—XD or fill) interlaced so that the warp and weft fibers travel up and over each other. As a result, woven fabrics tend to “tighten up” as they are loaded during service. It is believed that this tightening is due to the pulling of the interlaced fibers into a relatively straight configuration under load, a process that continues over time under constant load. There is, therefore, a corresponding decrease in fabric pore (or opening) size, and hence the permeability of the fabric. That is, as the fibers straighten, the openings in the fabric, which enable the tube to pass water therethrough, decrease in size. Thus, the filtration and dewatering capabilities of the tube decrease over time due to the fabric's woven structure. The unfavorable result for the user is a dewatering process that takes longer to complete.

Second, a woven fabric is not only interlaced, but the load bearing fibers are crimped. Therefore, as indicated above, it is believed that the interlaced fibers initially tighten up as they are pulled into a relatively straight configuration. As a result, the tube shows strain deformations that increase over time as the tube is filled and as the loading in the fabric increases. This relatively high strain characteristic of a woven product limits both the ability to pump material into the tube at high pumping pressure and the overall amount of material that can be placed into the tube due to safety concerns. The result for the user is a dewatering process that takes longer to complete, requires more tubes filled to a lower overall volume, and poses a greater risk of rupture of the tube.

### SUMMARY OF THE INVENTION

The present invention overcomes the above-described limitations of the prior art by providing a geotextile that has a knitted structure, and a geotextile tube constructed thereof. By virtue of the knitted structure, the load bearing warp fibers and weft fibers remain substantially straight, i.e., in a relatively flat orientation, rather than interlaced as in a woven product. As a result, the load bearing fibers take up stress immediately, thereby giving higher performance at lower strain.

According to a preferred embodiment of the present invention, the geotextile includes a pattern of oriented warp fibers positioned substantially parallel to each other, a pattern of inserted oriented weft fibers positioned substantially parallel to each other and substantially perpendicular to the oriented warp fibers, a nonwoven fleece, and oriented knitting fibers that interconnect the oriented warp fibers, the oriented weft fibers, and the nonwoven fleece as a knitted structure. The substantially parallel oriented warp fibers and the substantially parallel oriented inserted weft fibers are the load bearing members of the fabric. The knitting fibers hold the load bearing warp and weft fibers in position and interconnect them to the nonwoven fleece.

One feature of the present invention is the configuration of the load bearing oriented warp fibers and oriented weft fibers in the knitted structure. Because the load bearing fibers are held in position by a grid-like structure of knitting fibers, the load bearing warp and weft fibers remain substantially straight, i.e., in a relatively flat orientation. That is, the load bearing fibers are not crimped, as they would be in a woven structure. Therefore, when subjected to loading, the load bearing fibers achieve their full tensile strength without the deformations associated with straightening of the crimped fibers in woven products. As a result, a geotextile tube constructed of the instant geotextile can typically be pumped longer, i.e., to a greater hydrostatic pressure, than a conventional woven tube.

Because the load bearing oriented warp and weft fibers are substantially straight, they tend to retain their characteristics for permeability under loading. This means that more water flows through and from the geotextile tube, even when fully loaded. The result is a dewatering process that is both faster and safer to complete.

Another feature of the present invention is that while each weft fiber is essentially straight, each warp fiber is configured longitudinally with a slight undulating configuration, i.e., the warp fiber has a pattern of repeating opposed minor undulations across a centerline of the warp fiber. The undulating configuration provides a location at which adjacent warp fibers are in relatively close proximity to each other such that the warp fibers can be secured to one another with the knitting fiber. The undulating warp fiber configuration enhances the structural integrity of the resulting geotextile.

Yet another feature of the present invention is that by virtue of a configuration that incorporates the nonwoven fleece as part of the knitted structure, the geotextile is able to retain even fine-grained material.

Still another feature of the present invention is that the geotextile disclosed herein is preferably made of a composite of oriented polyester and randomly oriented polypropylene fibers. This preferred composite structure provides a combination of high tenacity, high modulus, low elongation, consistent flow rate, and good permeability during filling and service.

Yet another feature of the present invention is that the combination of the knitted structure with the oriented polyester and randomly oriented polypropylene materials of construction provides a durable geotextile that is resistant not only to the stresses of hydraulic and solids filling, but to ultraviolet (“UV”) degradation.

An object of the present invention, therefore, is to provide a knitted geotextile having load bearing oriented fibers that achieve their full tensile strength under loading without deformation, thereby providing for longer dewatering pumping times and safer operation.

Another object of the present invention is to provide a geotextile in which each weft fiber is essentially straight while each warp fiber has a slight undulating configuration, i.e., with a pattern of repeating opposed minor undulations across a centerline of the warp fiber so as to enhance the structural integrity of the geotextile.

Still another object of the present invention is to provide a geotextile capable of retaining even fine-grained material.

Still another object of the present invention is to provide a geotextile that is a composite of oriented polyester and randomly oriented polypropylene fibers, thereby providing a combination of high tenacity, high modulus, low elongation, consistent flow rate, and good permeability during filling and service.

Yet another object of the present invention is to provide a geotextile that combines a knitted structure with polyester and polypropylene materials of construction, thereby providing a durable material that is resistant not only to the stresses of hydraulic and solids filling, but to ultraviolet degradation.

Another object of the present invention is to provide a geotextile tube that is constructed of the aforementioned knitted geotextile.

Another object of the present invention is to provide a geotextile tube that is suitable for use in industrial and mine waste/slurry dewatering, dredged material disposal, dewatering and storage of contaminated geomaterials, and erosion control, including for estuarine and river applications, without adverse impact to the environment.

Still another object of this invention to be specifically enumerated herein is to provide a knitted geotextile and a geotextile tube in accordance with the preceding objects that will conform to conventional forms of manufacture, be of relatively simple construction and easy to use so as to provide a knitted geotextile and a geotextile tube that will be economically feasible, long lasting, durable in service, relatively trouble free in operation, and a general improvement in the art.

These together with other objects and advantages which will become subsequently apparent reside in the details of construction and operation as more fully hereinafter described and claimed, reference being had to the accompanying drawings forming a part hereof, wherein like reference numbers refer to like parts throughout. The accompanying drawings are intended to illustrate the invention, but are not necessarily to scale.

### BRIEF DESCRIPTION OF THE DRAWINGS

FIG. 1 is a magnified photographic plan view of a knitted geotextile in accordance with the present invention.

FIG. 2 is an enlarged plan view of a section of the knitted geotextile shown in FIG. 1, enlarged approximately 5 times.

FIG. 3 is a cross-sectional view of the knitted geotextile shown in FIGS. 1 and 2 taken along the section line “3-3” in a machine direction.

FIG. 4 is a cross-sectional view of the knitted geotextile shown in FIGS. 1 and 2 taken along the section line “4-4” in a cross machine direction.

FIG. 5 is an enlarged plan view of the reverse side of a section of the knitted geotextile shown in FIGS. 1 and 2.

FIG. 6 is a photograph showing a perspective view of a geotextile tube in accordance with the present invention that is constructed of the knitted geotextile illustrated in FIGS. 1 and 2.

FIG. 7 is a partial cross-sectional view of the geotextile tube illustrated in FIG. 6 which shows an embodiment of the invention in which a nonwoven fleece is located on an interior surface of the tube.

FIG. 8 is a partial cross-sectional view of the geotextile tube illustrated in FIG. 6 which shows an embodiment of the invention in which the nonwoven fleece is located on an exterior surface of the tube.

FIG. 9 is an enlarged plan view of a section of a knitted geotextile having multi-axial weft insertion in accordance with another embodiment of the present invention.

### DETAILED DESCRIPTION OF THE PREFERRED EMBODIMENTS

Although preferred embodiments of the invention are explained in detail, it is to be understood that other embodiments are possible. Accordingly, it is not intended that the invention is to be limited in its scope to the details of constructions, and arrangement of components set forth in the following description or illustrated in the drawings. The invention is capable of other embodiments and of being practiced or carried out in various ways. Also, in describing the preferred embodiments, specific terminology will be resorted to for the sake of clarity. It is to be understood that each specific term includes all technical equivalents that operate in a similar manner to accomplish a similar purpose. Where possible, components of the drawings that are alike are identified by the same reference numbers.

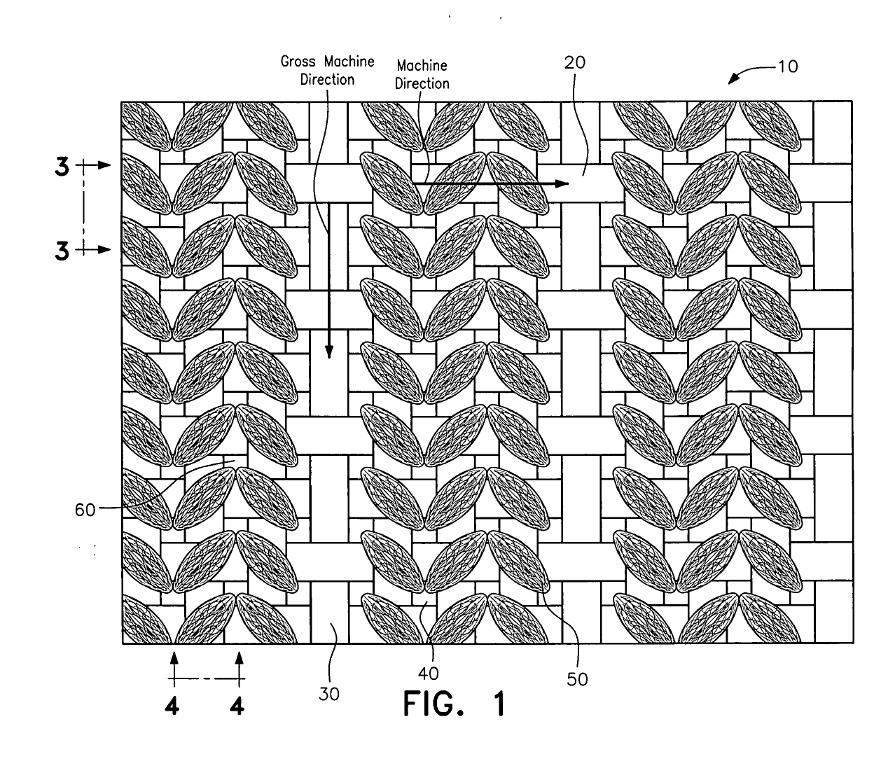

Referring now specifically to FIGS. 1-5 of the drawings, a knitted geotextile in accordance with the present invention is generally designated by reference number 10. The geotextile 10 includes in general a plurality of continuous load bearing fibers, also known as yarns, that are inlayed into the structure substantially parallel to each other across the width of the fabric and substantially parallel to each other across the length of the fabric, and a grid-like structure of knitting fibers, also known as yarns, that hold the load bearing fibers in position. More specifically, the knitted geotextile 10 includes a pattern of oriented warp fibers 20 positioned substantially parallel to each other, a pattern of oriented weft fibers 30 positioned substantially parallel to each other and substantially perpendicular to the oriented warp fibers 20, a nonwoven fleece 40, and oriented knitting fibers 50 that interconnect the warp fibers 20, the weft fibers 30, and the nonwoven fleece 40 as a knitted structure. The pattern of weft fibers 30 overlays the pattern of warp fibers 20 and the nonwoven fleece 40 overlays the pattern of weft fibers 30.

The knitted geotextile 10 provides an open mesh that includes a plurality of apertures or openings 60 resulting from the pattern of oriented warp fibers 20 positioned substantially parallel to each other that is overlaid with the pattern of oriented weft fibers 30 positioned substantially parallel to each other and substantially perpendicular to the oriented warp fibers 20. The knitted structure is configured to have a porosity that allows the passage of a fluid such as water therethrough while retaining fluid-suspended solids such as fine-grained sediments therein.

As shown in FIG. 2, each warp fiber 20 has an undulating configuration. The warp fibers 20 have a pattern of repeating opposed minor undulations across a centerline of the warp fiber. According to a preferred embodiment of the invention, the repeating offset of an undulating portion of the warp fibers 20 from a centerline thereof is from greater than 0 mm to approximately 3 mm. As shown in FIG. 2, one function of the undulating warp fiber configuration, also known as “relaxation in the stitch,” is to provide a location 21 at which adjacent warp fibers 20 are in relatively close proximity to each other such that the warp fibers can be secured to one another with the knitting fiber 50. The undulating warp fiber configuration enhances the structural integrity of the resulting geotextile 10.

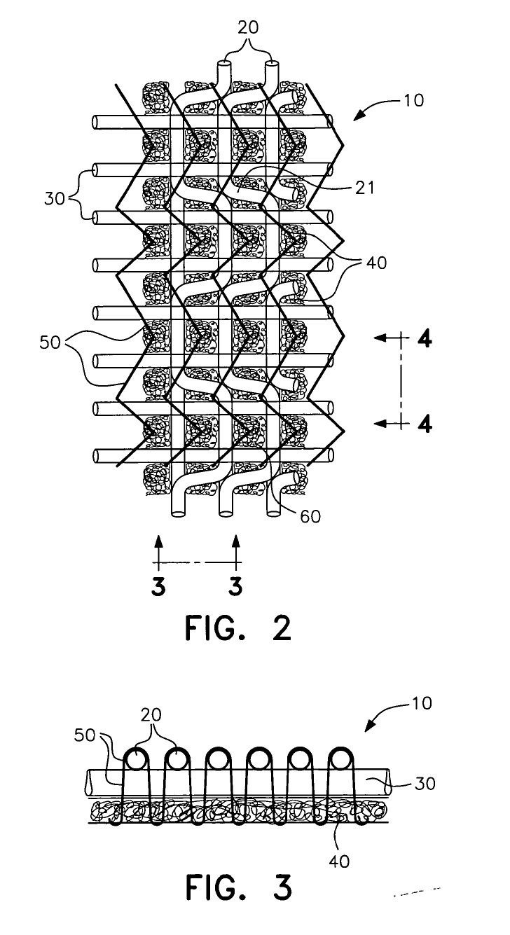

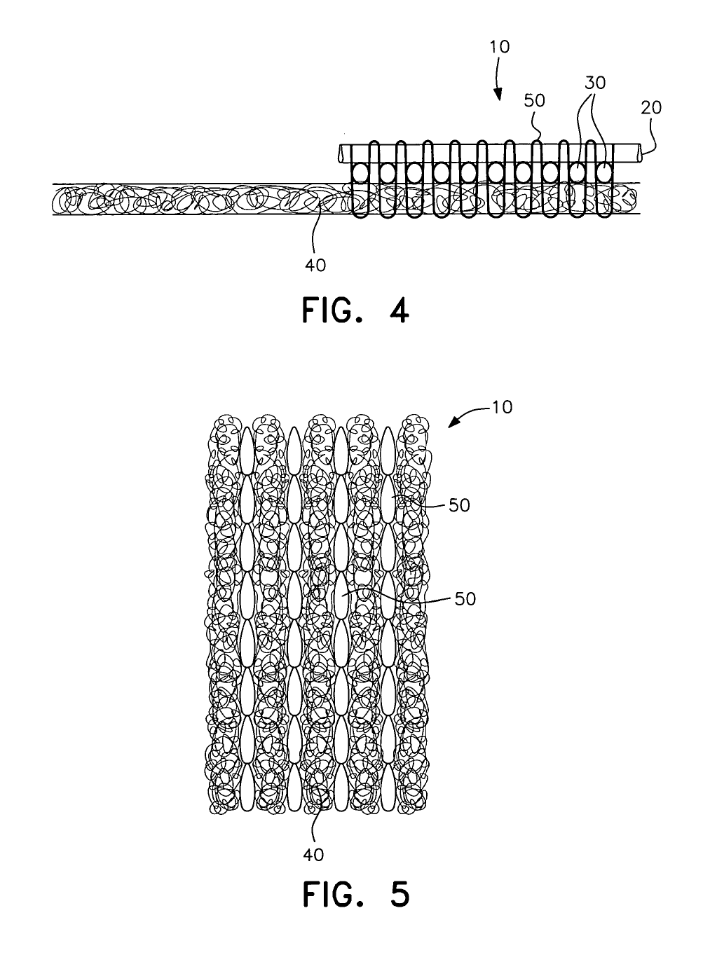

According to a preferred embodiment of the invention, the geotextile 10 is a bi-axial weft insertion knitted (“WIK”) structure. The nature of the weft insertion knitting process is known to those skilled in the art, such as is described in an RS 3-4 MSU-V operating manual available from Karl Mayer, GmbH, Germany, and therefore is not described further herein. A weft insertion knitted configuration ensures that the weft fibers 30 are positioned adjacent the warp fibers 20 without the aforementioned interlaced “up-and-over” pattern of a woven structure. Furthermore, as shown in FIGS. 3 and 4, by virtue of fabricating the geotextile 10 with weft insertion knitting with fleece capability, not only are the warp fibers 20 and weft fibers 30 connected by the knitting fiber 50, but the nonwoven fleece 40 is knitted into the geotextile 10 as well.

The materials of construction of the oriented fibers, i.e., the warp fibers 20, the weft fibers 30, and the knitting fibers 50, can be selected from, for example, polyester, polypropylene, polyethylene, coir, sisal, jute, flax, nylon, Kevlar® aramid, carbon, and glass. The materials of construction of the non-oriented fibers, i.e., the fibers of the nonwoven fleece 40, can be selected from, for example, polyester, polypropylene, polyethylene, coir, sisal, jute, flax, and cotton. The geotextile 10 can be constructed of various combinations of the warp fibers 20, the weft fibers 30, the nonwoven fleece 40 fibers, and the knitting fibers 50 that represent various combinations of the aforementioned fiber materials of construction. According to still another possible embodiment of the invention, the knitting fibers 50 can be constructed of a non-oriented fiber.

According to a preferred embodiment of the invention, however, the knitted geotextile 10 is made of a composite of oriented polyester fibers and randomly oriented polypropylene fibers. This composite structure provides a combination of high tenacity, high modulus, low elongation, consistent flow rate, and good permeability during filling and service. The oriented polyester fibers are preferred not only because of their strength, but also because of their ultraviolet (“UV”) functionality, i.e., their resistance to ultraviolet degradation. According to a preferred embodiment of the invention, the oriented warp fiber 20 and the oriented weft fiber 30 are of polyester construction, the nonwoven fleece 40 is of randomly oriented polypropylene construction, and the knitting fiber 50 is of oriented polyester construction.

According to a more preferred embodiment of the knitted geotextile 10, the warp fibers 20 are constructed of oriented polyethylene terephthalate (i.e., “PET”), the weft fibers 30 are also constructed of oriented polyethylene terephthalate, the nonwoven fleece 40 is constructed of randomly oriented polypropylene, and the knitting fiber 50 is constructed of oriented polyester. The polyethylene terephthalate construction provides the warp fibers 20 and the weft fibers 30 with strength, extension (i.e., stiffness), and the ability to wick. By virtue of polypropylene's hydrophobic nature, the polypropylene construction of the nonwoven fleece 40 provides for both enhanced filtration and drainage.

According to a still more preferred embodiment, the warp fibers 20 are constructed of an oriented four fold, 1100 dtex (i.e., 4400 dtex total) high tenacity polyester, typically polyethylene terephthalate, the weft fibers 30 are constructed of an oriented four fold, 1100 dtex (i.e., 4400 dtex total) high tenacity polyester, typically polyethylene terephthalate, the nonwoven fleece 40 is constructed of a thermally bonded continuous filament randomly oriented polypropylene having a density of 80 grams per square meter, and the knitting fibers 50 are constructed of an oriented two fold, 167 dtex (i.e., 334 dtex total) texturized polyester.

According to another embodiment of the invention as shown in FIGS. 6-8, a geotextile tube generally designated by reference number 110 is constructed of the geotextile 10. The geotextile tube 110 is typically formed from a sheet of the above-described knitted geotextile 10 folded in half upon itself and stitched around three sides of the adjacent edges. Thus, upon being filled, the structure has a generally tubular shape. The knitted geotextile 10 of the geotextile tube 110 includes a pattern of oriented warp fibers 20 positioned substantially parallel to each other, a pattern of oriented weft fibers 30 positioned substantially parallel to each other and substantially perpendicular to the oriented warp fibers 20, a nonwoven fleece 40, and oriented knitting fibers 50 that interconnect the warp fibers 20, the weft fibers 30, and the nonwoven fleece 40 as a knitted structure.

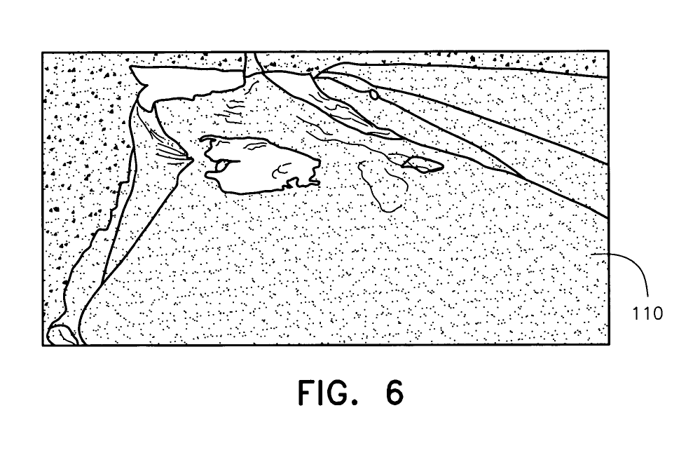

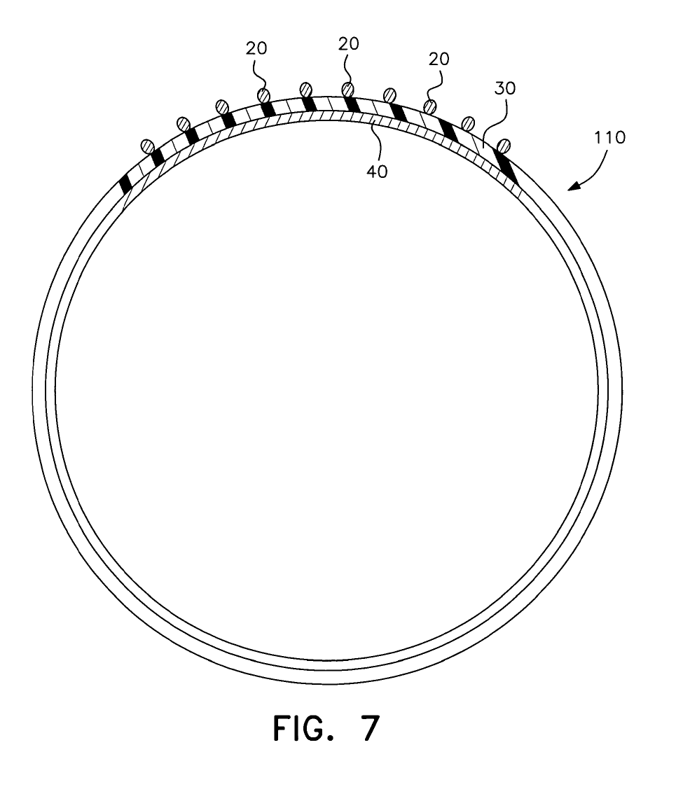

According to one embodiment of the present invention shown in FIG. 7, the nonwoven fleece 40 is disposed as an interior surface of the geotextile tube 110. In this configuration, the nonwoven fleece 40 would typically be employed for filtration, such as, for example, the filtration of fine-grained material.

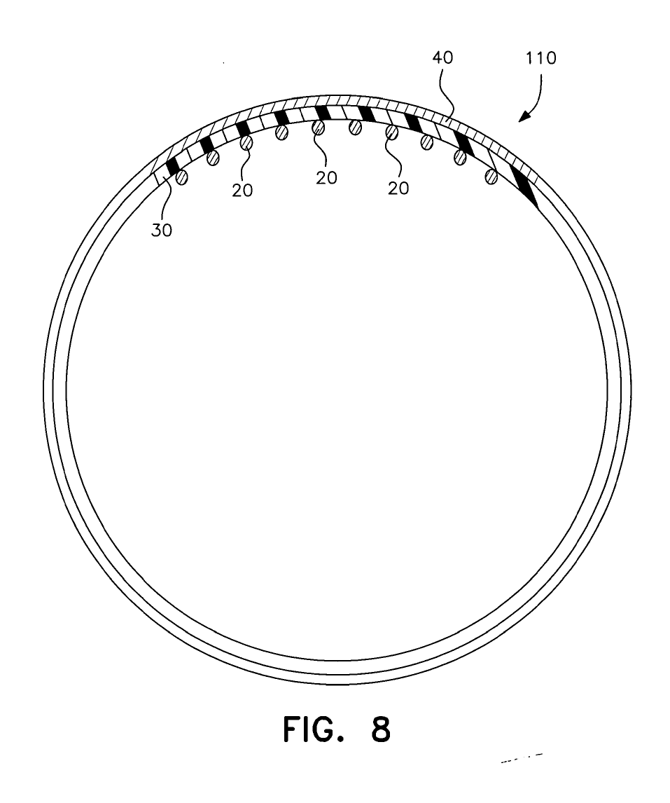

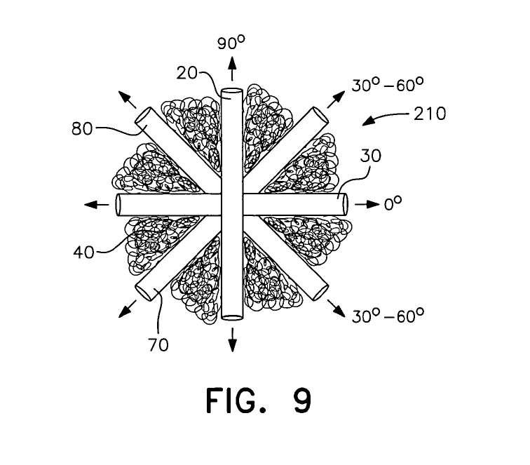

According to another embodiment of the invention shown in FIG. 8, the nonwoven fleece 40 is disposed as an exterior surface of the geotextile tube 110. This configuration is typically employed where the nonwoven fleece 40 is configured to protect the warp fibers 20 and the weft fibers 30 from mechanical abrasion during installation or service, and/or from ultraviolet degradation.

To enhance either the filtration or the protection functions described above, the geotextile tube 110 can include a plurality of the nonwoven fleeces 40 arranged in a stacked or layered configuration.

The knitted structure of the geotextile tube 110 is configured to have a porosity that allows the passage of a fluid such as water therethrough and that retains fluid-suspended solids therein. According to one embodiment of the invention, the knitted structure is configured to pass therethrough an effluent fluid that includes less than 50 ppm total of the suspended solids. As a result, the effluent from the geotextile tube 110 can generally comply with the National Pollutant Discharge Elimination System (“NPDES”) regulations of most jurisdictions in the United States.

By virtue of the above-described features of the knitted structure and the associated materials of construction, the geotextile tube 110 can be fabricated in various sizes depending upon the desired application. Representative values of properties of two examples of geotextile tubes according to the present invention are presented below. The properties listed below were derived from quality control testing performed at BTTG and other approved NAMAS/GAI-LAP laboratories.

### Example 1

| | | ENGLISH/ | |
|---|---|---|---|
| | TEST | IMPERIAL | SI/METRIC |
| PROPERTY | METHODS | VALUES | VALUES |
| Tube | | | |
| Circumference | Measured | 14′4″/28′8″/43′ | 4.4 m/8.8 m/ |
| (nominal) | | | 13.2 m |
| Length (standard) | Measured | 100′/150′/300′ | 30 m/45 m/90 m |
| Fill port size | Measured | 12″/18″ | 300 mm/450 mm |
| (diameter) | | | |
| Fill port spacing | Measured | 25′/50′ | 7.5 m/15 m |
| (typical) | | | |
| Fabricator seam | ASTM D4884 | 400 lbf/in | 70 kN/m |
| strength | | | |
| Geocomposite | | | |
| Wide width tensile | ASTM D4595 | 690/690 lbf/in | 120/120 kN/m |
| strength | | | |
| Extension at break | ASTM D4595 | 11.8/10.1% | |
| Puncture strength | ASTM D4833 | 600 lb | 2650N |
| Apparent opening | ASTM D4751 | 230 US | 0.068 mm |
| size (AOS) | | standard | |
| | | sieve equiv. | |
| Permittivity | ASTM D4491 | 0.95/s | |
| Flow rate | ASTM D4491 | 78 gal/min/ft² | 3130 l/min/m² |
| Endurance | | | |
| UV resistance % | ASTM D4355 | 59% @ 500 h | |
| remaining | | | |

### Example 2

| | | ENGLISH/ | |
|---|---|---|---|
| | TEST | IMPERIAL | SI/METRIC |
| PROPERTY | METHODS | VALUES | VALUES |
| Tube | | | |
| Circumference | Measured | 14′4″/28′8″/43′ | 4.4 m/8.8 m/ |
| (nominal) | | | 13.2 m |
| Length (standard) | Measured | 100′/150′/300′ | 30 m/45 m/90 m |
| Fill port size | Measured | 12″/18″ | 300 mm/450 mm |
| (diameter) | | | |
| Fill port spacing | Measured | 25′/50′ | 7.5 m/15 m |
| (typical) | | | |
| Fabricator seam | ASTM D4884 | 600 lbf/in | 105 kN/m |
| strength | | | |
| Geocomposite | | | |
| Wide width tensile | ASTM D4595 | 810/810 lbf/in | 140/140 kN/m |
| strength | | | |
| Extension at break | ASTM D4595 | 12.7/8.0% | |
| Puncture strength | ASTM D4833 | 600 lb | 2650N |
| Apparent opening | ASTM D4751 | 230 US | 0.069 mm |
| size (AOS) | | standard | |
| | | sieve equiv. | |
| Permittivity | ASTM D4491 | 1.12/s | |
| Flow rate | ASTM D4491 | 92 gal/min/ft² | 3690 l/min/m² |
| Endurance | | | |
| UV resistance % | ASTM D4355 | 59% @ 500 h | |
| remaining | | | |

FIG. 9 is an enlarged plan view of a knitted geotextile 210 in accordance with another embodiment of the present invention in which the fabric includes multi-axial weft insertion. The knitted geotextile 210 includes a pattern of oriented warp fibers 20 positioned substantially parallel to each other, a pattern of oriented weft fibers 30 positioned substantially parallel to each other and substantially perpendicular to the oriented warp fibers 20, a nonwoven fleece 40, and oriented knitting fibers 50 that interconnect the warp fibers 20, the weft fibers 30, and the nonwoven fleece 40 as a knitted structure. The pattern of weft fibers overlays the pattern of warp fibers 20 and the nonwoven fleece 40 overlays the pattern of weft fibers 30. In addition, the geotextile 210 includes, inserted between the pattern of weft fibers 30 and the nonwoven fleece 40, a pattern of oriented weft fibers 70 positioned substantially parallel to each other and a pattern of oriented weft fibers 80 positioned substantially parallel to each other. In this embodiment of the invention, the knitting fibers 50 also connect the weft fibers 70 and the weft fibers 80 to the remainder of the geotextile 210, i.e., the warp fibers 20, the weft fibers 30, and the nonwoven fleece 40.

According to this multi-axial weft insertion embodiment of the present invention, the approximately 90° angle of the warp fiber 20 and the approximately 0° angle of the weft fiber 30 are fixed. However, the angle of the oriented weft fibers 70 and the angle of the oriented weft fibers 80 can each range from approximately 30° to approximately 60° based on the travel angle of the weft insertion carriages.

The knitted geotextile 10 according to the present invention includes at least the following advantages. First, because the load bearing warp fibers 20 and weft fibers 30 are held in position by the grid-like structure of the knitting fibers 50, the load bearing fibers 20, 30 remain substantially straight, i.e., in a relatively flat orientation. That is, the load bearing fibers 20, 30 are not crimped, as they would be in a woven structure. Therefore, when subjected to loading, the load bearing fibers 20, 30 achieve their full tensile strength without the deformations associated with straightening of the crimped fibers in woven products. As a result, a geotextile tube constructed of the instant geotextile 10 can typically be pumped longer, i.e., to a greater hydrostatic pressure, than a conventional woven tube.

Even more specifically, because the load bearing fibers 20, 30 are substantially straight (rather than interlaced as in a woven product), they take up stress immediately, thereby giving higher performance at lower strains. Conversely, because woven fabrics are interlaced, they initially tighten up and thus extend more prior to taking up load. The geotextile 10 therefore has a higher stiffness modulus than a woven fabric. The result for the user is a dewatering process that is more predictable and relatively faster to complete. Additionally, repeated pumping can be more efficiently performed, since each stage of re-pumping with geotextile 10 begins with the fibers having not tightened-up as significantly as is the case with a woven product. This enables the geotextile tube 110 to exhibit greater porosity than a woven tube. Furthermore; with each repeated pumping of the tube, this porosity disparity increases.

Because the warp fibers 20 and weft fibers 30 are substantially straight, they tend to retain their design characteristics for permeability under loading. This means that more water flows through and from the geotextile tube 110, even when fully loaded. Conversely, woven fabrics tighten up as they are loaded, with a corresponding decrease in pore size and hence permeability. The result for the user is a dewatering process that is relatively faster and safer to complete.

The geotextile 10, therefore, provides a knitted structure having more exact filtration design capabilities, i.e., one not influenced by strain in a woven fabric or a relatively significant decrease in the porosity of the woven fabric over time under the increased loading associated with increased filling of the tube. In addition, the geotextile 10 provides the ability to utilize higher tube pumping pressures at lower strains, which increases safety and broadens the user's filling options. And, unlike a woven fabric, the knitted structure of the geotextile 10 can be configured to achieve the desired balance of tensile strength, permittivity, and opening size.

Second, by virtue of a configuration that incorporates the nonwoven fleece 40 as part of the knitted structure, the geotextile 10 is able to retain even fine grained material.

Third, the polyester and polypropylene fibers of the geotextile 10 provide a combination of high tenacity, high modulus, low elongation, consistent flow rate, and good permeability during filling and service.

Fourth, the combination of the knitted structure with the polyester and polypropylene materials of construction provides a durable geotextile 10 that is resistant not only to the stresses of hydraulic and solids filling, but to ultraviolet degradation.

It is not intended that the present invention be limited to the specific embodiments described herein. The foregoing is considered as illustrative only of the principles of the invention. For example, although the knitted geotextile 10 has been described as being configured for sediment dewatering, the geotextile could be employed in a different service in which the characteristics and properties of the knitted structure, including the materials of construction, would be beneficial, such as for example, the protection of marine structures.

Furthermore, although the knitted geotextile 10 has been described as including the nonwoven fleece 40, other embodiments of the invention that do not include the nonwoven fleece are possible. For example, the knitted geotextile 10 can include a pattern of oriented warp fibers 20 positioned substantially parallel to each other, a pattern of oriented weft fibers 30 positioned substantially parallel to each other and substantially perpendicular to the oriented warp fibers 20, and oriented knitting fibers 50 that interconnect the warp fibers 20 and the weft fibers 30 as a knitted structure. The knitted geotextile 210 multi-axial weft insertion embodiment of the invention can also be formed without the nonwoven fleece.

The aforementioned embodiments of the knitted geotextile without the nonwoven fleece might be particularly suitable for a dewatering service in which it is acceptable to remove only larger particles, i.e., particles larger than those which would be removed from the effluent by the nonwoven fleece.

Similarly, although the structure that is constructed of the geotextile has been described as being tubular in shape, the geotextile structure could be of a different shape, such as, for example, a bag, depending upon the service in which the structure is to be employed.

Further, since numerous modifications and changes will readily occur to those skilled in the art, it is not desired to limit the invention to the exact construction and operation shown and described, and, accordingly, all suitable modifications and equivalents may be resorted to, falling within the scope of the invention.

What is claimed is:

1. A knitted geotextile for sediment dewatering and containment, comprising:
a pattern of oriented warp fibers positioned substantially parallel to each other;
a pattern of oriented weft fibers positioned substantially parallel to each other and substantially perpendicular to the oriented warp fibers;
a nonwoven fleece; and
oriented knitting fibers that interconnect the warp fibers, the weft fibers, and the nonwoven fleece as a knitted structure.

2. The knitted geotextile according to claim 1, wherein the knitted structure is a bi-axial weft insertion knitted configuration.

3. The knitted geotextile according to claim 1, wherein the knitted structure includes a plurality of openings provided by the oriented patterns of the warp fibers and the weft fibers.

4. The knitted geotextile according to claim 1, wherein the pattern of weft fibers overlays the pattern of warp fibers and the nonwoven fleece overlays the pattern of weft fibers.

5. The knitted geotextile according to claim 1, wherein the warp fibers and the weft fibers are continuous and load bearing.

6. The knitted geotextile according to claim 1, wherein the warp fiber and the weft fiber are of polyester construction.

7. The knitted geotextile according to claim 6, wherein the warp fiber and the weft fiber each include four folds of 1100 dtex polyester.

8. The knitted geotextile according to claim 1, wherein the nonwoven fleece is of thermally bonded continuous filament polypropylene construction.

9. The knitted geotextile according to claim 8, wherein the nonwoven fleece has a density of 80 grams per square meter.

10. The knitted geotextile according to claim 1, wherein the knitting fiber is of texturized polyester construction.

11. The knitted geotextile according to claim 10, wherein the knitting fiber includes two folds of 167 dtex texturized polyester.

12. A geotextile tube for sediment dewatering and containment, comprising a knitted geotextile having a tubular shape that includes a pattern of oriented warp fibers positioned substantially parallel to each other, a pattern of oriented weft fibers positioned substantially parallel to each other and substantially perpendicular to the oriented warp fibers, a nonwoven fleece, and oriented knitting fibers that interconnect the warp fibers, the weft fibers, and the nonwoven fleece as a knitted structure.

13. The geotextile tube according to claim 12, wherein the nonwoven fleece is disposed as an interior surface of the tube.

14. The geotextile tube according to claim 13, wherein the nonwoven fleece is configured for filtration.

15. The geotextile tube according to claim 12, wherein the nonwoven fleece is disposed as an exterior surface of the tube.

16. The geotextile tube according to claim 15, wherein the nonwoven fleece is configured to protect the warp fibers and the weft fibers from at least one of mechanical abrasion and ultraviolet degradation.

17. A knitted geotextile for sediment dewatering and containment, comprising:
a pattern of oriented polyester warp fibers positioned substantially parallel to each other;
a pattern of oriented polyester weft fibers positioned substantially parallel to each other and substantially perpendicular to the warp fibers so as to lay against a side of the warp fibers;
a nonwoven polypropylene fleece; and
oriented knitting fibers that interconnect the warp fibers, the weft fibers, and the nonwoven fleece as a weft insertion knitted structure that includes a plurality of openings provided by the oriented patterns of the warp fibers and the weft fibers.

18. The knitted geotextile according to claim 17, wherein the knitted structure includes a plurality of the nonwoven polypropylene fleeces.

19. The knitted geotextile according to claim 17, wherein the knitted structure is configured to have a porosity that allows the passage of a fluid therethrough and that retains fluid-suspended solids therein.

20. The knitted geotextile according to claim 19, wherein the knitted structure is configured to pass therefrom an effluent fluid that includes less than 50 ppm total of the suspended solids.

21. The knitted geotextile according to claim 1, wherein the warp fiber is configured longitudinally as a pattern of repeating minor undulations.

22. The knitted geotextile according to claim 21, wherein an offset of an undulating portion of the warp fiber from a centerline thereof is from greater than 0 mm to approximately 3 mm.

23. The knitted geotextile according to claim 6, wherein the polyester is polyethylene terephthalate.

24. The knitted geotextile according to claim 1, wherein the nonwoven fleece is of randomly oriented polypropylene construction.

25. A knitted geotextile for sediment dewatering and containment, comprising:
a pattern of oriented warp fibers positioned substantially parallel to each other;
a pattern of oriented weft fibers positioned substantially parallel to each other and substantially perpendicular to the oriented warp fibers; and
oriented knitting fibers that interconnect the warp fibers and the weft fibers as a knitted structure.

26. The knitted geotextile according to claim 25, further comprising a nonwoven fleece that is interconnected to the warp fibers and the weft fibers by the knitting fibers.
